(19) United States
(12) Patent Application Publication
(10) Pub. No.: US 2026/0053112 A1
(43) Pub. Date: Feb. 26, 2026

(54) PET CHASE TOY

(71) Applicant: Hartdesign! Ltd., CHICAGO, IL (US)

(72) Inventor: Mark Hartelius, CHICAGO, IL (US)

(21) Appl. No.: 19/103,255

(22) PCT Filed: Aug. 14, 2023
(86) PCT No.: PCT/US2023/030145

§ 371 Date: Feb. 12, 2025

Related U.S. Application Data
(60) Provisional application No. 63/397,506, filed on Aug. 12, 2022.

(51) Int. Cl. A01K 15/02

(52) U.S. Cl. CPC A01K 15/0252

(57) ABSTRACT

A dog chase toy with audio, visual, and/or haptic sensory feedback is described herein. The dog chase toy includes sensors to detect the current state of the dog chase toy. These states may include, for example, being held by a person, traveling through the air, hitting and/or being in contact with the ground, and/or being in the mouth of the dog, etc. Based on the current state, the dog chase toy provides audio, visual, and/or haptic sensory feedback.

### RELATED APPLICATIONS

The application claims priority to U.S. Provisional Application No. 63/397,506 entitled, “DOG CHASE TOY,” filed Aug. 12, 2022, which is incorporated by reference in its entirety.

### TECHNICAL FIELD

The present invention is generally related to pet toys and, more specifically, a toy to provide audio and/or visual stimulation to a pet that may also be used as a training tool.

### BACKGROUND

Keeping animal companions, such as cats and dogs, active and engaged can improve the animal companion's quality of life. Some breeds, if not stimulated enough, will express antisocial behavior. Additionally, inactivity can adversely affect the health of the animal companion. Toys that satisfy an animal companion's instinct to hunt can help keep the animal companion engaged while maintaining the animal companion's interest over time.

### SUMMARY

A dog chase toy with audio, visual, and/or haptic sensory feedback is described herein. The dog chase toy includes sensors to detect the current state of the dog chase toy. These states may include, for example, being held by a person, traveling through the air, hitting and/or being in contact with the ground, and/or being in the mouth of the dog, etc. Based on the current state, the dog chase toy provides audio, visual, and/or haptic sensory feedback. In one example, the dog chase toy may make a sound mimicking an animal (e.g., a duck, etc.) after being thrown and may change the sound when the toy detects pressure being asserted by the mouth of the dog. In some such examples, the sound may vary based on the pressure being asserted by the mouth of the dog.

In accordance with one aspect, there is provided a throwing toy for a pet. The throwing toy may include an outer housing, a sensor adapted to detect a state of the throwing toy, and a controller disposed in the outer housing and adapted to receive input data associated with the state, the controller being operable to provide audible, visual, or haptic feedback based on the state.

In accordance with another aspect, the throwing toy may further include any of the following or all of the following in any combination:
a speaker disposed in the outer housing and operatively connected to the controller, the speaker being configured to emit the audible feedback to an external environment.
an LED disposed in the outer housing and operatively connected to the controller, the LED being configured to emit light to an external environment.
wherein the outer housing is translucent such that the light transmitted via the LED is visible outside of the outer housing.
wherein the sensor comprises at least one of: a pressure sensor, a piezoelectric device, an accelerometer, a spring-based sensor, and a haptic device.
an inner housing disposed in the outer housing and dimensioned to receive a circuit board and a battery, said circuit board comprising the controller, and said battery adapted to supply power to the throwing toy.
wherein the circuit board comprises a connector port thereon adapted to receive a connector to electrically couple the connector to the circuit board.
wherein the throwing toy further comprises a cover removably attached to the outer housing, said cover being removable to access the inner housing.
wherein the cover is adapted to sealingly engage with the outer housing to inhibit water ingress in the inner housing.
wherein the outer housing includes a lug disposed thereon with a strap attached thereto, said strap being operable to grasp and throw the throwing toy.
wherein the controller is a wireless controller, said wireless controller being configured to wirelessly communicate with a remote device for receiving inputs by a user.
wherein the inputs comprise an animal type and a prey type, wherein the wireless controller is adapted to tailor the audible, visual, or haptic feedback based on the animal type and the prey type.
wherein the outer housing comprises a buoyancy material therein such that the throwing toy is positively buoyant in water.

In accordance with another aspect, there is provided a throw toy for a pet. The throw toy may include an outer housing and a cover dimensioned to enclose the outer housing, the outer housing defining one or more sound apertures to facilitate transmitting sound therethrough, an LED light, a speaker disposed in the outer housing, a sensor adapted to detect a state of the throw toy, and a circuit board enclosure disposed in the outer housing and dimensioned to receive a circuit board. The circuit board includes a controller and a connector port, the controller comprising logic to emit a sound and/or a light based on the state, and the connector port being configured to receive a connector to electrically couple the circuit board to the connector.

In accordance with another aspect, the throw toy may further include any of the following or all of the following in any combination:
wherein the cover is adapted to sealingly engage the outer housing to inhibit water ingress.
wherein the throw toy further comprises a cap removably attached to the circuit board enclosure, said cap defining a first aperture dimensioned to receive the connector port threrethrough, and a second aperture dimensioned to receive a button therethrough.
wherein the circuit board enclosure defines a sound aperture dimensioned to receive a waterproof membrane therein.

In accordance with another aspect, there is provided a toy for a pet. The toy may include a housing including a top case and a bottom case defining an interior therebetween, a strap attached to the top case or the bottom case, the strap being operable to throw the toy, wherein one of the top case or the bottom case defines a depression dimensioned to receive a removable cover for sealingly enclosing the interior from water ingress, the depression defining a connector aperture therethrough, and a sensor disposed in or about the housing, the sensor being operable to detect a state of the toy, and a controller disposed in the housing and configured to control sound or light emitted from the toy based on the state of the toy.

In accordance with another aspect, the throw toy may further include any of the following or all of the following in any combination:
wherein the controller is a wireless controller, said wireless controller being configured to wirelessly communicate with a remote device for receiving inputs by a user.
wherein the inputs comprise an animal type and a prey type, wherein the wireless controller is adapted to tailor audible, visual, or haptic feedback based on the animal type and the prey type.
wherein the housing comprising a buoyancy material therein such that the toy is positively buoyant in water.
wherein the controller is adapted to emit a first sound and a second sound, wherein the first sound corresponds to a first state of the toy, and the second sound corresponds to a second state of the toy.

### BRIEF DESCRIPTION OF THE DRAWINGS

Operation of the present disclosure may be better understood by reference to the following detailed description taken in connection with the following illustrations, wherein:

FIGS. 1A and 1B illustrate perspective views of an elongated throw toy, in accordance with the teachings of this disclosure.

FIG. 2 is an exploded view of the elongated throw toy of FIGS. 1A and 1B, in accordance with the teachings of this disclosure.

FIG. 3 is a cross-sectional view of the elongated throw toy of FIGS. 1A and 1B, in accordance with the teachings of this disclosure.

FIGS. 4A and 4B illustrate perspective views of a spherical throw toy, in accordance with the teachings of this disclosure.

FIGS. 4C and 4D illustrate enlarged perspective views of an example outer housing of the spherical throw toy of FIGS. 4A and 4B, in accordance with the teachings of this disclosure.

FIG. 5 is an exploded view of the spherical throw toy of FIGS. 4A and 4B, in accordance with the teachings of this disclosure.

FIG. 6 is a cross-sectional view of the spherical throw toy of FIGS. 4A and 4B, in accordance with the teachings of this disclosure.

FIG. 7 is a block diagram of a circuit to provide feedback within the throw toys of FIGS. 1A and 1B and FIGS. 4A and 4B, in accordance with the teachings of this disclosure.

FIGS. 8A and 8B are partial, schematic diagrams of exemplary arrangements for detecting impact.

### DETAILED DESCRIPTION

Reference will now be made in detail to exemplary embodiments of the present disclosure, examples of which are illustrated in the accompanying drawings. It is to be understood that other embodiments may be utilized, and structural and functional changes may be made without departing from the respective scope of the present disclosure. Moreover, features of the various embodiments may be combined or altered without departing from the scope of the present disclosure. As such, the following description is presented by way of illustration only and should not limit in any way the various alternatives and modifications that may be made to the illustrated embodiments and still be within the spirit and scope of the present disclosure.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a”and “an”are generally intended to mean “one or more”unless context suggests otherwise.

A throwing toy for a pet may comprise an outer housing, a sensor adapted to detect a state of the throwing toy, and a controller disposed in the outer housing and adapted to receive input data associated with the state, said controller being operable to provide audible, visual, or haptic feedback based on the state.

The throwing toy may further comprise any of the following or all of the following in any combination:
a speaker disposed in the outer housing and operatively connected to the controller, said speaker being configured to emit the audible feedback to an external environment.
an LED disposed in the outer housing and operatively connected to the controller, said LED being configured to emit light to an external environment.
wherein the outer housing is translucent such that the light transmitted via the LED is visible outside of the outer housing.
wherein the sensor comprises at least one of: a pressure sensor, a piezoelectric device, an accelerometer, a spring-based sensor, and a haptic device.
an inner housing disposed in the outer housing and dimensioned to receive a circuit board and a battery, said circuit board comprising the controller, and said battery adapted to supply power to the throwing toy.
wherein the circuit board comprises a connector port thereon adapted to receive a connector to electrically couple the connector to the circuit board.
wherein the throwing toy further comprises a cover removably attached to the outer housing, said cover being removable to access the inner housing.
wherein the cover is adapted to sealingly engage with the outer housing to inhibit water ingress in the inner housing.
wherein the outer housing includes a lug disposed thereon with a strap attached thereto, said strap being operable to grasp and throw the throwing toy.
wherein the controller is a wireless controller, said wireless controller being configured to wirelessly communicate with a remote device for receiving inputs by a user.
wherein the inputs comprise an animal type and a prey type, wherein the wireless controller is adapted to tailor the audible, visual, or haptic feedback based on the animal type and the prey type.
wherein the outer housing comprises a buoyancy material therein such that the throwing toy is positively buoyant in water.

A throw toy for a pet, said throw toy may comprise an outer housing and a cover dimensioned to enclose the outer housing, said outer housing defining one or more sound apertures to facilitate transmitting sound therethrough, an LED light, a speaker disposed in the outer housing, a sensor adapted to detect a state of the throw toy, and a circuit board enclosure disposed in the outer housing and dimensioned to receive a circuit board, said circuit board comprising a controller and a connector port, said controller comprising logic to emit a sound and/or a light based on the state, and said connector port being configured to receive a connector to electrically couple the circuit board to the connector.

The throw toy may further comprise any of the following or all of the following in any combination:
wherein the cover is adapted to sealingly engage the outer housing to inhibit water ingress.
wherein the throw toy further comprises a cap removably attached to the circuit board enclosure, said cap defining a first aperture dimensioned to receive the connector port threrethrough, and a second aperture dimensioned to receive a button therethrough.
wherein the circuit board enclosure defines a sound aperture dimensioned to receive a waterproof membrane therein.

A toy for a pet may comprise a housing including a top case and a bottom case defining an interior therebetween, a strap attached to the top case or the bottom case, said strap being operable to throw the toy, wherein one of the top case or the bottom case defines a depression dimensioned to receive a removable cover for sealingly enclosing the interior from water ingress, said depression defining a connector aperture therethrough, and a sensor disposed in or about the housing, said sensor being operable to detect a state of the toy, and a controller disposed in the housing and configured to control sound or light emitted from the toy based on the state of the toy.

The throw toy may further comprise any of the following or all of the following in any combination:
wherein the controller is a wireless controller, said wireless controller being configured to wirelessly communicate with a remote device for receiving inputs by a user.
wherein the inputs comprise an animal type and a prey type, wherein the wireless controller is adapted to tailor audible, visual, or haptic feedback based on the animal type and the prey type.
wherein the housing comprising a buoyancy material therein such that the toy is positively buoyant in water.
wherein the controller is adapted to emit a first sound and a second sound, wherein the first sound corresponds to a first state of the toy, and the second sound corresponds to a second state of the toy.

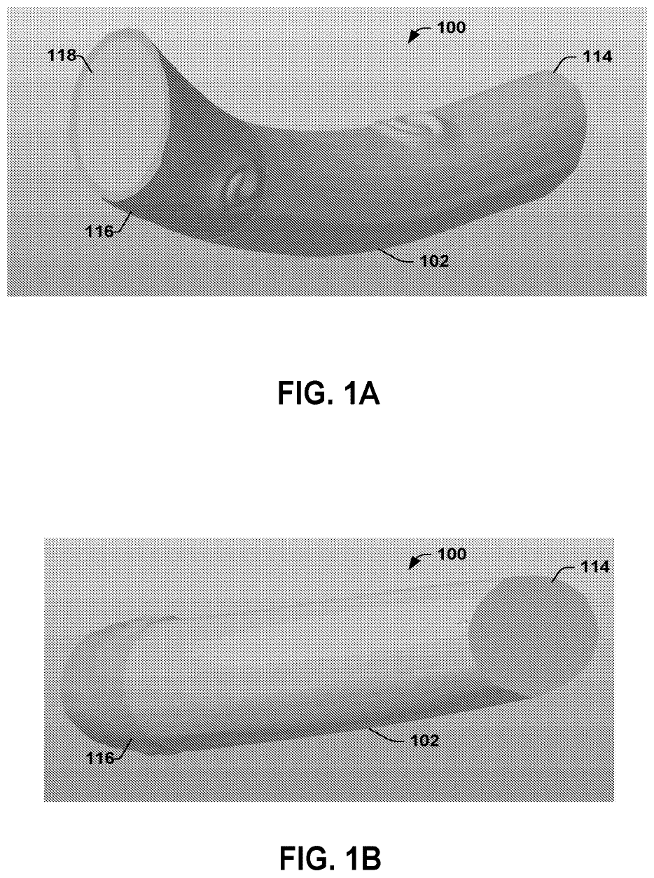

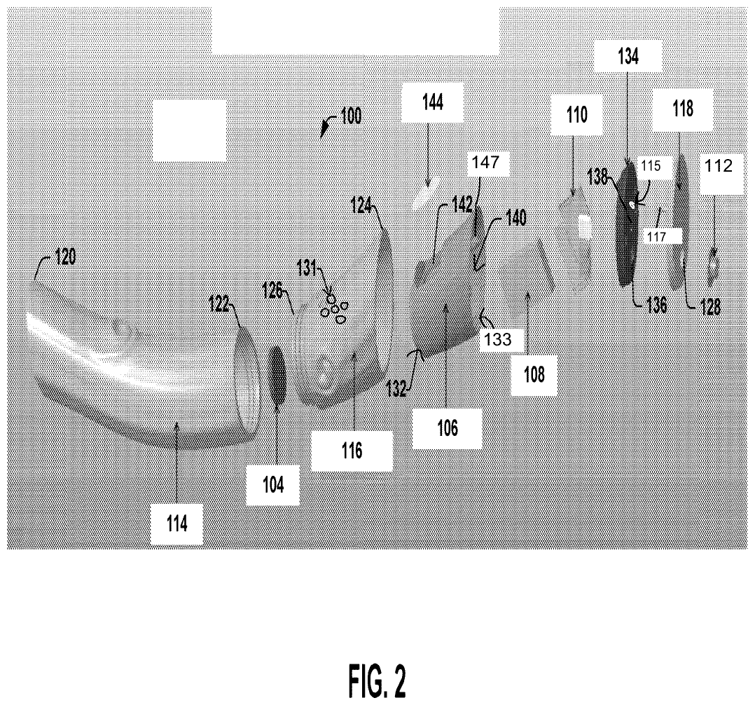

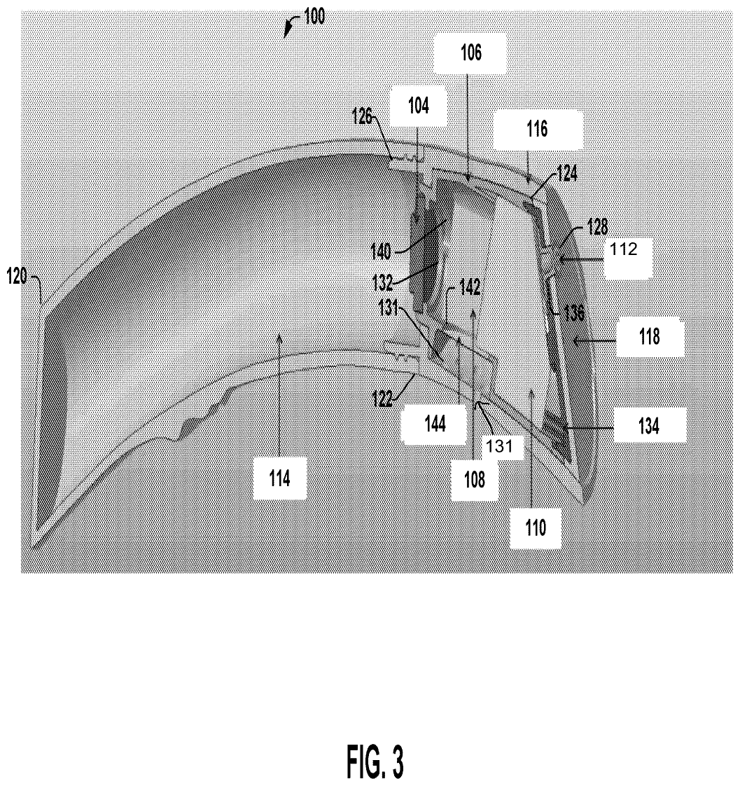

FIGS. 1A, 1B, 2, and 3 illustrate an example throw toy 100 with an elongated form to simulate, for example, a stick (sometimes referred to as the “elongated throw toy 100”). FIGS. 1A and 1B illustrate perspective views of the throw toy 100. FIG. 2 illustrates an exploded view of the throw toy 100. FIG. 3 illustrated a cross-section of the throw toy 100. The elongated throw toy 100 provides audio, visual, and/or haptic feedback to encourage interaction with the elongated throw toy 100 by a pet, such as a dog.

Referring to the examples shown in FIGS. 1A-2, the elongated throw toy 100 includes a housing 102 (sometimes referred to as an “outer housing”), a speaker 104, a circuit board enclosure or protector 106 (sometimes referred to as an “inner housing”), a battery 108, a circuit board 110, and a button 112. The housing 102 includes an elongated portion 114, an end portion 116, and a cover 118. In the illustrated embodiment, the elongated portion 114 includes indentations on an outer surface thereof corresponding to dog bone indicia. It is contemplated that a variety of different indentations, surface patterns, colors, or textures may be utilized to emulate various types of bones or prey. The elongated portion 114 has a proximal end 122 and a distal end 120. The elongated portion 114 is hollow. The distal end 120 is closed. The proximal end 122 is open and, in the illustrated example, includes threading to facilitate removably attaching the end portion 116 to the elongated portion 114. The speaker 104 may be configured to emit the audible feedback to an external environment.

The end portion 116 has a proximal end 124 and a distal end 126. In the illustrated example, the distal end 126 is threaded to removably attach to the elongated portion 114. In the illustrated examples, the elongated portion 114 and the end portion 116 are detachably connected when the elongated throw toy 100 is assembled, alternatively, the elongated portion 114 and the end portion 116 may be integrally formed. The cover 118 fits into the proximal end 124 of the end portion 116. In the illustrate example, the cover 118 defines a button aperture 128 through which the button 112 protrudes to be accessible. The end portion 116 defines one or more the sound apertures 131 to facilitate playing sound, i.e., transmitting sound waves from within the housing 102 to the external environment.

The circuit board protector 106 is configured to fit within the end portion 116 of the housing 102. In some examples, at least a portion of the circuit board protector 106 is configured to snap fit into the end portion 116. In some examples, the circuit board protector 106 is made of a stiffer and/or more resilient material than the housing 102. The circuit board protector 106 defines a speaker aperture 132 in which the speaker 104 is affixed (e.g., glued into, snap fit into, friction fit into, etc.). Opposite the speaker aperture 132, the circuit board protector 106 defines an opening 133 into which a cap 134 is affixed (e.g., glued into, snap fit into, friction fit into, etc.). In some embodiments, the circuit board protector 106 may include one or more bosses 147 protruding outwardly from a cavity 140 thereof adapted to rotatably receive and engage with a fastener (e.g., a screw) extended through an opening (not shown) of the cap 134 to secure the cap 134 to the circuit board protector 106. In some embodiments, the circuit board protector 106 may define a plurality of holes and the cap 134 may include a corresponding number of shafts configured to friction fit into the holes to secure the cap 134 to the circuit board protector 106. The cap 134 defines a button aperture 136 through which the button 112 protrudes to be accessible by a user. In some examples, the cover 118 defines a connector aperture 138 through which a connector (e.g., a Universal Serial Bus (USB) connector) may pass to electrically couple to the circuit board 110.

In some examples, the cap 134 defines a cover aperture 115 to accept a corresponding shaft 117 of the cover 118 to friction fit the cover 118 to the cap 134. The cover 118 may be removable from the housing 102 and the cap 134 to expose the connector aperture 138, but otherwise serves to seal the connector aperture 138 (and the connector on the circuit board 110) when the cover 118 is attached to the cap 134, for example, when a connector is not plugged into the circuit board 110. In some embodiments, the cover 118 may comprise a gasket or a silicone material adapted to sealingly engage with the cap 134 or the outer housing to prevent water ingress into the throw toy 100.

The circuit board protector 106 defines a cavity 140 between the speaker aperture 132 and the opening 133. The battery 108 and the circuit board 110 are disposed in the cavity 140. Within the cavity 140, the speaker 104, the battery 108, the circuit board 110, and the button 112 are electrically coupled.

In the illustrated example, the circuit board protector 106 defines a sound aperture 142 to accept a waterproof membrane 144 that facilitates transmitting sound (i.e., transmitted through the circuit board protector 106) to an external environment, while protecting the cavity 140 from moisture. The sound aperture 142 of the circuit board protector 106 is coaxial with the sound aperture(s) 131 of the end portion 116 of the housing 102.

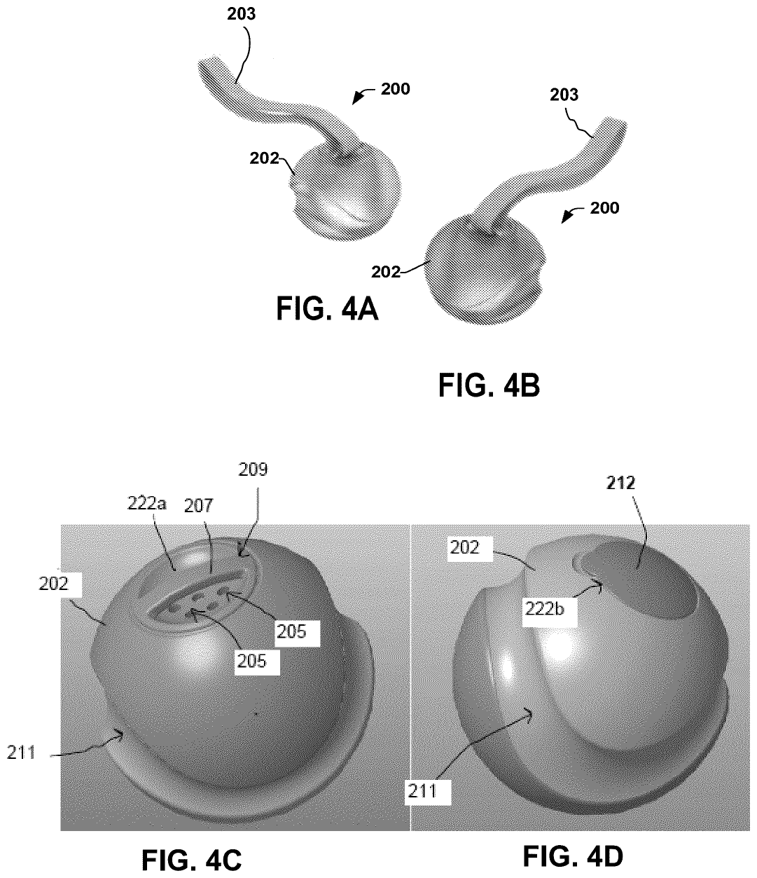

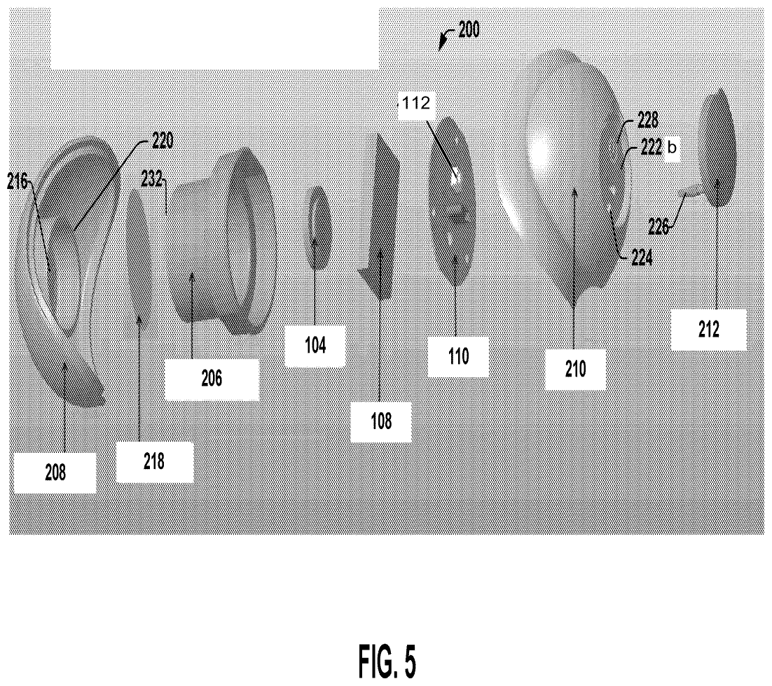

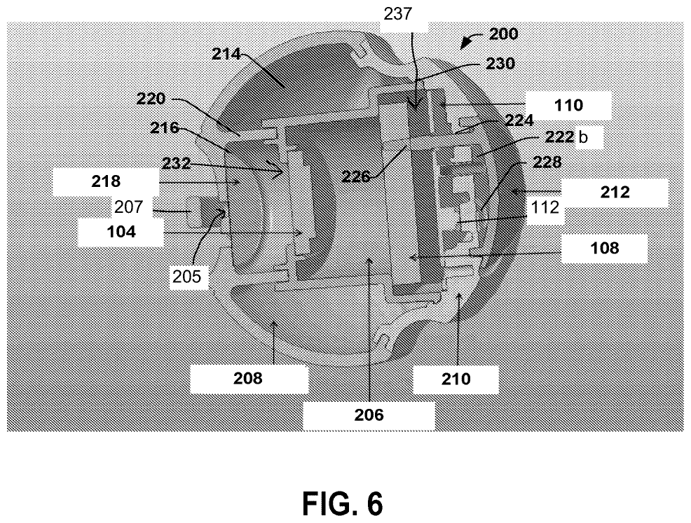

FIGS. 4A, 4B, 5, and 6 illustrate an example throw toy 200 with a spherical form (sometimes referred to as “curved” or “spherical throw toy 200”). FIGS. 4A and 4B illustrate perspective views of the throw toy 200. FIG. 5 illustrates an exploded view of throw toy 200. FIG. 6 illustrated a cross-section of the throw toy 200. The spherical throw toy 200 provide audio, visual, and/or haptic feedback to encourage interaction with the throw toy 200 by a pet, such as a dog.

In the illustrated example, the throw toy 200 includes an outer housing 202 with a strap 203 attached thereto and functional to grasp and throw the throwing toy 200. Referring to FIGS. 4C and 4D, the outer housing 202 defines a first depression 222a, and a lug 207 extends over the first depression 222a. In the illustrated embodiment, the lug 207 and the first depression 202a form part of an insert 209 that is removably attached to the outer housing 202, e.g., in a snap fit manner or via mating threads. It is also contemplated that the lug 207 and the first depression 202a may be integrated with the outer housing 202, e.g., and formed together therewith.

The lug 207 and the first depression 222a collectively define a gap therebetween dimensioned to receive a portion of the strap 203 therethrough. In this manner, the strap 203 may be secured to the outer housing 202 via the lug 207. The first depression 222a defines one or more apertures 205 communicating with a sound aperture 216 (FIG. 6) of the throw toy 200 for transmitting sound to an external environment. In some embodiments, it is contemplated that the apertures 205 may be formed in other portions of the outer housing 202 (outside of the first depression 222a).

Referring to FIGS. 4D and 5, the outer housing 202 may define a second depression 222b, for example, on an opposite side of the first depression 222a, as shown. A cover 212 is removably attached to the second depression 222b, as discussed in detail below. The housing 202 also defines an indented surface 211 extending around the housing 202. The indented surface 211 embodies a gripping surface, for example, to enable a dog to grip the throw toy 200 with its teeth.

Turning to FIGS. 5 and 6, the outer housing 202 comprises a bottom case 208 and a top case 210 defining an interior 214 therebetween. The bottom case 208 and the top case 210 fit together (e.g., snap fit, friction fit, fixed with adhesive, etc.) A speaker 104 (e.g., a waterproof ceramic speaker), an inner housing 206 (also referred to as a “circuit board protector”), a battery 108, a circuit board 110, and a button 112 are disposed in the interior 214. The bottom case 208 defines a sound aperture 216 that facilitates transmitting sound generated by the speaker 104 to the exterior of the throw toy 200 via the apertures 205 (FIG. 4C) of the outer housing 202. The sound aperture 216 is configured to accept a waterproof membrane 218 that facilitates transmitting sound (exiting the circuit board protector 206) while protecting the interior 214 of the throw toy 200 from any moisture collected on the outer housing 202. In the illustrated example, the bottom case 208 includes a cylindrical portion 220 that protrudes into the interior 214 and surrounds the sound aperture 216.

The top case 210 includes the second depression 222b that defines a cover aperture 224 configured to receive a flared connected interface 226 of the cover 212. The flared connected interface 226 is flared to facilitate insertion into the cover aperture 224 and to resist removal from the cover aperture 224. When the cover 212 is inserted into the cover aperture 224, the cover has a fit position and a loose position. In the fit position, the cover 212 is affixed (e.g., snap fit, friction fit, etc.) inside the second depression 222b such that the curvature of the cover 212 corresponds with the curvature of the top case 210 at the location of the second depression 222b. The second depression 222b also defines a button cover portion 228 to facilitate access to the button 112. In some examples, the second depression 222b defines a connector aperture to facilitate a connector (e.g., a Universal Serial Bus (USB) connector) being inserted into a corresponding port on the circuit board 110.

The inner housing 206 is configured to fit within the interior 214 of the outer housing 202. In the illustrated examples, the inner housing 206 is configured to interface with the cylindrical portion 220 (FIG. 6) of the bottom case 208 and a snap interface 230 of the top case 210. In some examples, the inner housing 206 is made of a stiffer and/or more resilient material than the outer housing 202. The inner housing 206 defines a speaker aperture 232 in which the speaker 104 is affixed (e.g., glued into, snap fit into, friction fit into, etc.). Opposite the speaker aperture 232, the inner housing 206 defines an opening 237 into which the battery 108 and the circuit board 110 are affixed. The inner housing 206 is configured to position the circuit board 110 adjacent to the second depression 222b to facilitate access to the button 112 and, in some examples a connector port, through the second depression 222b.

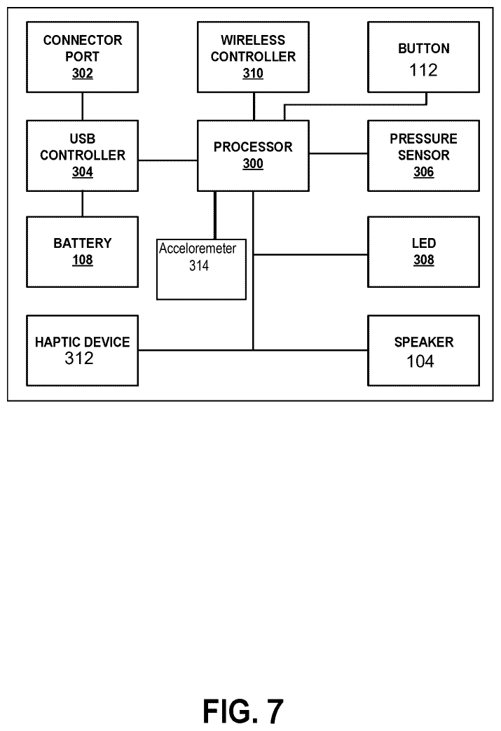

FIG. 7 is a block diagram of electrical component of the throw toy 100 and 200 that comprises a circuit positioned on and/or electrically coupled to the circuit board 110. In the illustrated example, the throw toy 100 and 200 includes a processor or controller 300, a connector port 302, a USB controller 304, the battery 108, the speaker 104, and the button 112. In some examples, the throw toy 100 and 200 may also include a light emitting diode (LED) 308 and a wireless controller 310. Preferably, the throw toy 100 and 200 includes one or more sensors for detecting a state of the throw toy, for example, whether the throw toy is in a static state (e.g., motionless), being thrown, being held, being gripped or chewed on, or contacting a ground surface. For this purpose, the one or more sensors may include a pressure sensor 306 to detect deflection of the outer housing 102 and 202, a haptic device 312 (e.g., a piezoelectric device for detecting contact), an accelerometer 314 for measuring the speed of the throw toy 100 and 200. In such embodiments, the processor or controller 300 is operatively connected to the USB controller 304, the wireless controller 310, the connector port 302, the button 112, the pressure sensor 306, the LED 308, the speaker 104, the haptic device 312, the accelerometer 314, and the battery 108. In this manner, the controller 300 is configured to receive input data from the sensors regarding a current state of the throw toy 100 and 200.

The controller 300 is configured to provide feedback based on the input data, for example, audible (e.g., via the speaker 104), visual (e.g., via the LED 308), or haptic feedback (e.g., via an actuator) and may be configured to tailor such. For example, in some embodiments, the controller 300 is configured to operate the speaker 104 to emit the sound of an animal in distress based on input data indicating that the toy has made contact with a ground surface. In other examples, it is contemplated that the controller 300 may operate the speaker 104 to emit the sound of an animal travelling in the air (e.g., a duck quacking) based on input data that the throw toy 100 and 200 is being thrown. It is also contemplated that the controller 300 may implement a particular light scheme based on the type of input data, for example, to emit a particular light color, intensity, or frequency. The controller 300 may comprise logic to emit a sound and/or a light based on a state.

The processor or controller 300 may be any suitable processing device or set of processing devices such as: a microprocessor, a microcontroller-based platform, a suitable integrated circuit, one or more field programmable gate arrays (FPGAs), and/or one or more application-specific integrated circuits (ASICs). The processor or controller 300 may include memory to, for example, store audio files to be played on the speaker 104. The memory may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, etc.), unalterable memory (e.g., EPROMs). In some examples, the memory includes multiple kinds of memory, particularly volatile memory and non-volatile memory. The processor or controller 300 may be programmed to perform the functions described herein. The controller 300 may be configured to control sound or light emitted from the toy based on the state of the toy.

The connector port 302 provides a detachable physical connection to a cable. The connector port 302 may be, for examples, a connector port for a USB connector. The connector port 302 is used in conjunction with the USB controller 304 to electrically and communicatively couple the cable to the throw toy 100 and 200. For example, the USB controller 304 may facilitate recharging the battery 108. In some examples, the USB controller 304 may facilitate transferring files to be stored in memory (e.g., firmware updates, sound files, control schema, etc.). The button 112 is an input interface for the user to interact with the processor 300. For example, the button 112 may be used to toggle the power of the throw toy 100 and 200. As another example, the button 112 may be used to change modes of the throw toy 100 and 200.

As noted above, the pressure sensor 306 may detect deflection of the outer housing 102 and 202 caused by, for example, the pet applying force to the throw toy 100 and 200 using its mouth. The signal from the pressure sensor 306 may be used to control the audio, visual, and/or haptic feedback provided to the pet. For example, (i) a first pressure threshold may indicate that the pet is not applying enough pressure and causes a first sound to be played, (ii) a second threshold may indicate that the pet is applying a desired amount of pressure and causes a second sound to play, and (iii) a third threshold may indicate that the pet is applying too much pressure and causes a third sound to play. In some embodiments, it is contemplated that one or more pressure sensors (e.g., impact pressure sensors, flexible piezoelectric pressure sensors, etc.) may be arranged about the throw toy 100 and 200 (e.g., embedded in a wall of the outer housing, adjacent to an inner surface of the outer housing, or on an outer surface thereof) and operatively connected to the circuit board 110 for detecting deflection, strain, vibrations, or impact. The LED 308 provides visual feedback. Preferably, the outer housing 102 and 202 is translucent such that light emitted from the LED 308 can be seen outside of the throw toy 100 and 200. In some examples, the processor 300 may control the LED 308 to provide a visual stimulus in a threshold time after the throw toy 100 and 200 strikes the ground. The haptic device 312 provides haptic feedback. For example, the processor 300 may control the haptic device 312 to provide intermittent haptic feedback after the throw toy 100 and 200 strikes the ground.

The wireless controller 310 may be in place of or supplemental to the connector port 302. The wireless controller 310 connects to a mobile device (e.g., a smart phone, a smart watch, a tablet computer, etc.). In some examples, the wireless controller 310 is configured in accordance with Bluetooth Low Energy (BLE) as specified in the Bluetooth Specification 4.0 (as revised) maintained by the Bluetooth Special Interest Group. Alternatively, in some examples, the wireless controller 310 may operate in accordance with other local area or personal area network standards, such as Bluetooth, IEEE 802.11 or IEEE 802.15.4. When connected to the mobile device, the wireless controller 310 facilitates input by a user to manually control the audio, visual, and/or haptic feedback and/or download files into the memory of the throw toy 100 and 200. The inputs may comprise an animal type and a prey type, where the wireless controller 310 is adapted to tailor the audible, visual, or haptic feedback based on the animal type and the prey type.

In some embodiments, the throw toy 100 and 200 may be wirelessly connected to a remote device, for example, a smartphone, a tablet, a computing device or the like. The system may include an application, software program or the like such that a user may open the app/software program on the applicable connected smartphone, tablet or computing device. The user may choose in the app/software program the type of animal they intend to use the throw toy 100 and 200 with. Specifically, the user may choose the type of dog, such as breed, breed combinations, size, type, age, or other characteristics of the dog with whom they are playing. The user may then pick a type of prey that they want the throw toy 100 and 200 to impersonate, such as for example a squirrel, duck, pheasant, or other small game. The app/software will choose the appropriate prey sound to make based on the items selected and will adjust the sound based on the specific characteristics of the dog selected.

The user may then throw the throw toy 100 and 200, and upon the throw toy 100 and 200 hitting the ground (or other object), the throw toy 100 and 200 may emit a predetermined sound. In one embodiment, the sound may comprise the noise the applicable game (e.g., squirrel, duck, pheasant, etc.) would make if it were in distress. This embodiment may be used as a training tool that allows a user to train a dog to retrieve a distressed animal such as one that is shot during hunting or so as to retrieve a dog in distress. In these embodiments, the throw toy 100 and 200 may comprise the configuration identified above. The throw toy 100 and 200 may include a pressure switch or trigger switch that when depressed initiates the sound described above. In one embodiment, the sensors for detecting a state of the throw toy 100 and 200 may comprise a pressure switch/trigger switch including a spring (or other biasing device) positioned in a sleeve and that includes a ball at an end thereof. Upon impact with the ground, the spring (or other biasing member) is depressed. The ball attached is then able to contact a switch (e.g., on the circuit board 110) to emit an applicable sound and/or illuminate a corresponding light via the LED 308. The spring (or other biasing member) may return the ball to its neutral position so that upon the next contact a switch can be activated to emit the applicable sound and/or light. While this embodiment is disclosed, any variation of switch may be utilized and the present teachings are not limited to the above embodiment.

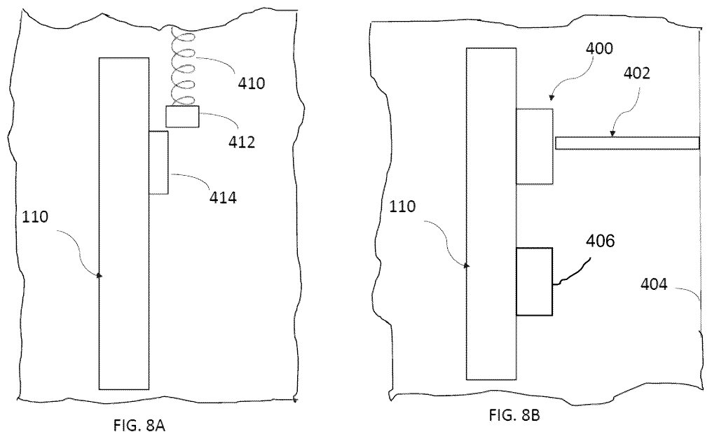

Referring to FIGS. 8A and 8B, the throw toy 100 and 200 may include other sensors for detecting a state of the throw toy 100 and 200. For instance, referring to FIG. 8A, the throw toy 100 and 200 may include a spring-based sensor 410 (e.g., attached to an inner wall thereof) with a weight 412 attached thereto adapted to contact a contact plate or switch 414 on the circuit board 110 upon impact, e.g., with a ground surface. In another embodiment, referring to FIG. 8B, the sensors may embody a piezoelectric device 400 arranged on the circuit board 110 for detecting various degrees of physical contact, for example, strain (e.g., a state of being held) or shock (e.g., hard impact with a ground surface). In some embodiments, it is contemplated that a protrusion 402 may extend from an inner surface 404 of the throw toy 100 and 200 (e.g., an inner surface of the circuit board protector or the outer housing) such that when the throw toy 100 or 200 contacts an object or a ground surface, the foregoing contact will cause the protrusion 402 to engage the piezoelectric device 400 to detect the corresponding impact.

In some embodiments, it is contemplated that the throw toy 100 and 200 may comprise a buoyancy material to keep the throw toy 100 and 200 afloat in water. For instance, the buoyancy material may be disposed in a void or hollow area of the throw toy 100 and 200 such that the throw toy 100 and 200 will remain afloat upon landing in water.

Although the embodiments of the present invention have been illustrated in the accompanying drawings and described in the foregoing detailed description, it is to be understood that the present disclosure is not to be limited to just the embodiments disclosed, but that the disclosure described herein is capable of numerous rearrangements, modifications and substitutions without departing from the scope of the claims hereafter. The terms “includes,” “including,” and “include” are inclusive and have the same scope as “comprises,” “comprising,” and “comprise” respectively. The claims as follows are intended to include all modifications and alterations insofar as they come within the scope of the claims or the equivalent thereof.

Having thus described the invention, the following is claimed:

1. A throwing toy for a pet comprising:
an outer housing;
a sensor adapted to detect a state of the throwing toy; and
a controller disposed in the outer housing and adapted to receive input data associated with the state, said controller being operable to provide audible, visual, or haptic feedback based on the state.

2. The throwing toy of claim 1, further comprising:
a speaker disposed in the outer housing and operatively connected to the controller, said speaker being configured to emit the audible feedback to an external environment.

3. The throwing toy of claim 1, wherein the throwing toy further comprises:
an LED disposed in the outer housing and operatively connected to the controller, said LED being configured to emit light to an external environment.

4. The throwing toy of claim 3, wherein the outer housing is translucent such that the light transmitted via the LED is visible outside of the outer housing.

5. The throwing toy of claim 1, wherein the sensor comprises at least one of: a pressure sensor, a piezoelectric device, an accelerometer, a spring-based sensor, and a haptic device.

6. The throwing toy of claim 1, wherein the throwing toy further comprises:
an inner housing disposed in the outer housing and dimensioned to receive a circuit board and a battery, said circuit board comprising the controller, and said battery adapted to supply power to the throwing toy.

7. The throwing toy of claim 6, wherein the circuit board comprises a connector port thereon adapted to receive a connector to electrically couple the connector to the circuit board.

8. The throwing toy of claim 7, wherein the throwing toy further comprises a cover removably attached to the outer housing, said cover being removable to access the inner housing.

9. The throwing toy of claim 8, wherein the cover is adapted to sealingly engage with the outer housing to inhibit water ingress in the inner housing.

10. The throwing toy of claim 1, wherein the outer housing includes a lug disposed thereon with a strap attached thereto, said strap being operable to grasp and throw the throwing toy.

11. The throwing toy of claim 1, wherein the controller is a wireless controller, said wireless controller being configured to wirelessly communicate with a remote device for receiving inputs by a user.

12. The throwing toy of claim 11, wherein the inputs comprise an animal type and a prey type, wherein the wireless controller is adapted to tailor the audible, visual, or haptic feedback based on the animal type and the prey type.

13. The throwing toy of claim 1, wherein the outer housing comprises a buoyancy material therein such that the throwing toy is positively buoyant in water.

14. A throw toy for a pet, said throw toy comprising:
an outer housing and a cover dimensioned to enclose the outer housing;
said outer housing defining one or more sound apertures to facilitate transmitting sound therethrough;
an LED light;
a speaker disposed in the outer housing;
a sensor adapted to detect a state of the throw toy; and
a circuit board enclosure disposed in the outer housing and dimensioned to receive a circuit board,
said circuit board comprising a controller and a connector port, said controller comprising logic to emit a sound and/or a light based on the state, and said connector port being configured to receive a connector to electrically couple the circuit board to the connector.

15. The throw toy of claim 14, wherein the cover is adapted to sealingly engage the outer housing to inhibit water ingress.

16. The throw toy of claim 14, wherein the throw toy further comprises a cap removably attached to the circuit board enclosure, said cap defining a first aperture dimensioned to receive the connector port threrethrough, and a second aperture dimensioned to receive a button therethrough.

17. The throw toy of claim 14, wherein the circuit board enclosure defines a sound aperture dimensioned to receive a waterproof membrane therein.

18. A toy for a pet, comprising:
a housing including a top case and a bottom case defining an interior therebetween;
a strap attached to the top case or the bottom case, said strap being operable to throw the toy,
wherein one of the top case or the bottom case defines a depression dimensioned to receive a removable cover for sealingly enclosing the interior from water ingress, said depression defining a connector aperture therethrough; and
a sensor disposed in or about the housing, said sensor being operable to detect a state of the toy; and a controller disposed in the housing and configured to control sound or light emitted from the toy based on the state of the toy.

19. The toy of claim 18, wherein the controller is a wireless controller, said wireless controller being configured to wirelessly communicate with a remote device for receiving inputs by a user.

20. The toy of claim 19, wherein the inputs comprise an animal type and a prey type, wherein the wireless controller is adapted to tailor audible, visual, or haptic feedback based on the animal type and the prey type.

21. The toy of claim 18, wherein the housing comprising a buoyancy material therein such that the toy is positively buoyant in water.

22. The toy of claim 18, wherein the controller is adapted to emit a first sound and a second sound, wherein the first sound corresponds to a first state of the toy, and the second sound corresponds to a second state of the toy.
